(19) United States
(12) Patent Application Publication
(10) Pub. No.: US 2016/0176679 A1
(43) Pub. Date: Jun. 23, 2016

(54) MECHANICAL EMERGENCY ENTRANCE AND EXIT APPARATUS

(71) Applicants: Shahin Kassai, Tehran (IR); Rostam Dinyariyan, Tehran (IR)

(72) Inventors: Shahin Kassai, Tehran (IR); Rostam Dinyariyan, Tehran (IR)

(21) Appl. No.: 15/044,656

(22) Filed: Feb. 16, 2016

(51) Int. Cl. B66B 9/00; B66B 11/02; B66B 3/00; B66B 11/04; E04H 9/00; B66B 5/00

(52) U.S. Cl. CPC B66B 9/00; E04H 9/00; B66B 5/0031; B66B 3/002; B66B 11/04; B66B 11/02

(57) ABSTRACT

An emergency entry and exit apparatus for evacuating people from a building, includes a set of four gears, mounting assemblies, a first chain and a second chain, multiple cabins, a shaft member. The cabins are positioned in series along the length of the first chain and the second chain, and a roof section of each cabin is attached to upper surfaces of the first chain and the second chain via a shaft member, where the first chain and the second chain are driven based on the difference in loading due to the weight of the people entering the cabins on opposing sides of the building which causes the cabins to be displaced along the outer contour of the building during the evacuation process, therefore allowing people to be transferred from one of the floors to another floor via the cabins moving in downward direction.

### BACKGROUND

There are numerous emergency evacuation methods and systems conventionally practiced across various countries depending on the geographical and security conditions in the respective countries. Such emergency safety systems include lifts: modified for quick evacuation of people from a building, designing of exit ways in skyscraper buildings which facilitate shortest distance for a person to travel to exit the building, emergency alarms installed in building walls and lifts which alert an impending danger, such as fire and smoke, based on telemetric information from sensors located in the building which enable people to take quick measures to escape the building, providing cushioned basement for buildings which help top reduce the impact of earthquakes or volcanic eruptions, security alert alarms which inform people in the building regarding a hostage situation and thereby constructing safe rooms within buildings to secure people, etc.

At times, evacuation is required, using emergency stairs is useless, time-consuming and impossible for the infirm. Auxiliaries and firemen also encounter difficulty in reaching upper floors of tall buildings. If firemen attend the place at vital time, they will be able to manage the crisis. Most of the alternatives which have been suggested to replace escape stairs have many shortcomings. They have considered only the process of evacuation and didn't offer any alternative for those who want to enter the building. Taking into account all the above mentioned information, many steps have been taken to integrate most of the evacuation systems, therefore focus has been concentrated on the fastest method of evacuation which points to the modification of lifts in buildings. Multiple modifications have been done in the design of lifts to make them more efficient and quick in evacuating maximum number of people in the shortest amount of time from a building.

However, even though convention designing of such evacuation methods using lifts have some disadvantages. Although all these systems are designed to increase safety, they are not immune completely. The building vibrations and the expansion and contraction of the entire system are not taken into consideration in most of the systems, and most of the systems are not designed to withstand earthquakes or bomb blasts. Almost all of the systems are designed for the outer space of buildings and are exposed to flames, consequently they will be useless and dangerous.

The process of using the present system is hazardous and there is no safe and immune way for entrance and exit because the present systems doesn't have moving platforms and conveyors which allow victims to safely enter and exit the danger spot. None of the systems define a special way which can considered for the entrance of auxiliaries and firemen without the help of external force. None of the systems detect a sensor based data which shows, for example, the amount of a poisonous gas, such as carbon monoxide which is circulating in the building since, so that the auxiliaries are able to determine their strategy for rescue operation with open eyes and prevent auxiliaries' losses. Most of the systems use independent power sources such as generators and power lines to drive the lifts which is again not completely dependable.

Hence, there is a long felt but unresolved need for an emergency entry and exit apparatus which addresses and resolves the above mentioned issues.

### SUMMARY OF THE INVENTION

The emergency entry and exit apparatus for evacuating people from a building, comprises a set of four gears, mounting assemblies, a first chain and a second chain, multiple cabins, a shaft member. The gears are fixedly attached at an upper section, and another set of four gears fixedly attached at a lower section of the building via mounting assemblies, where the gears are positioned relative to each other in a single plain along the upper section and lower section of the building, and are interlocked in a loop via a first chain and a second chain in a substantially parallel orientation to each other. The cabins are positioned in series along the length of the first chain and the second chain, and a roof section of each cabin is attached to upper surfaces of the first chain and the second chain via a shaft member, where the first chain and the second chain are driven based on the difference in loading due to the weight of the people entering the cabins on opposing sides of the building which causes the cabins to be displaced along the outer contour of the building during the evacuation process, therefore allowing people to be safely transferred from one of the floors to another floor via the cabins moving in downward direction, and to allow rescue officials to enter the building through the other cabins which are moving in the upward direction.

In an embodiment, the emergency entry and exit apparatus further comprises compressed air channels positioned between adjacent to the cabins and in fluid communication with the cabins, where the compressed air channels are configured to generate a positive air pressure within each cabin and also safe room to protect the people occupied within the cabin from fire and smoke when cabin or safe room doors are opened. In an embodiment, the emergency entry and exit apparatus further comprises gearboxes to control speed of the displacement of cabins, where the cabins comprise emergency stop switches configured to stop the movement of the cabins, therefore allowing unloading of auxiliaries and moving injured people. In an embodiment, the emergency entry and exit apparatus further comprises safe rooms positioned adjacent to the emergency entry and exit apparatus, where the safe rooms are fitted with a safe doors configured to allow entry and exit of people into the emergency entry and exit apparatus, where each safe door is configured to be accessed by a person present inside the safe room. In an embodiment, each mounting assembly positioned at the lower section of the building comprises one or combination of a fixed foundation and a floating foundation gearbox. The fixed foundation is defined by vertical mounting plates configured to receive one or more of the gears, and the floating foundation gearbox is configured to receive another one or more of the gears, where the floating foundation gearbox is defined as hollow unit comprising a telescopically suspended gearbox configured to be in contact and sliding communication with the inner lining of the mounting assembly to absorb the system variation like chains elongation.

In an embodiment, the emergency entry and exit apparatus further comprises one or more oxygen cylinders positioned within each cabin to provide oxygen for the people being evacuated from the building. In an embodiment, each cabin comprises a set of doors, where each door is a sliding door defined by adjacently positioned rectangular sliding plates configured to be slid open, and the set of doors comprise a front door, a rear door, and a pair of side doors. The front door is configured to allow the entry of people, the rear door is configured to allow entry and exit for the auxiliaries, and the side doors are configured to evacuate the people at the lower section of the building. In an embodiment, a movable platform configured to allow the entry and exit of the people in to the cabins, where the height of the movable platform is configured to be adjusted with the height of the floor of the cabin electronically and moves parallel to the cabin. In an embodiment, each cabin comprises wheels positioned on adjoining edges, and bearing members, where the wheels and bearing members, in combination, is configured to prevent a pendulum movement of the cabin, and each wheel is positioned on a spring member to prevent damage caused by vibrations.

In an embodiment, the emergency entry and exit apparatus further comprises movable trapdoors positioned on a top portion and a bottom portion of each cabin, where if at the time of entering the cabin, person foot was placed between cabin and movable platform, the trapdoor moves upwards to prevent their foot from injury. In an embodiment, the height of each cabin floor and a floor in the building is different at every instance of the displacement of the cabin causing the people to enter the cabins asynchronously, thereby preventing damage to the cabin construction. In an embodiment, the emergency entry and exit apparatus further comprises weight sensors positioned within each cabin configured to automatically close the doors of the cabin when the weight of the people occupied within the cabin reaches a maximum safety value. In an embodiment, monitoring and telemetry systems are positioned in each safe room configured to assist rescue officials to collect data regarding the extent of damage within the building, such as, but not limited to temperature, smoke, etc., and thereby to administer and determine their situation when leaving the safe room. When auxiliaries arrives to the considered floor and step-down from the apparatus, they enter an small room which is inside the safe room to avoid them from crowd and helps them to step-down from apparatus without interfering with other people. This room's door can be opened only by firemen from inside.

### BRIEF DESCRIPTION OF THE DRAWINGS

FIG. 1 exemplarily illustrates a side perspective view of the emergency entry and exit apparatus, further showing a three dimensional view of the compressed air channel.

FIG. 2A exemplarily illustrates a plan view of the building which shows the safe room and layout of the cabin, and the layout of the system of compressed air channels comprising of the main channel and sub-branches in front of the entrances to the safe rooms.

FIG. 2B exemplarily illustrates a top perspective view of the cabin, auxiliaries exit place, movable trapdoors, and the door which opens from one side for rescue official use.

FIG. 3A exemplarily illustrates a top perspective view of a partially exploded view of a floor of the building, showing the emergency entry and exit apparatus.

FIG. 3B exemplarily illustrates a top perspective enlarged view of a portion of the emergency entry and exit apparatus as shown in FIG. 3A, showing the cabins with the stairs and movable platform in front of the cabins.

FIG. 4A exemplarily illustrates a side perspective view of a bottom portion of the building, showing the fixed foundation and floating foundation gearbox.

FIG. 4B exemplarily illustrated an enlarged view of the floating foundation gearbox as marked by the portion A in FIG. 4A.

FIG. 5 exemplarily illustrates a front elevation view of the emergency entry and exit apparatus, showing a partial view of the cabin at the time of exiting the runner, situated at the highest point or top portion of the building, further showing horizontal movement of the cabin and, and entering the next runner.

FIG. 6 exemplarily illustrates a top perspective view of the cabin.

### DETAILED DESCRIPTION OF THE INVENTION

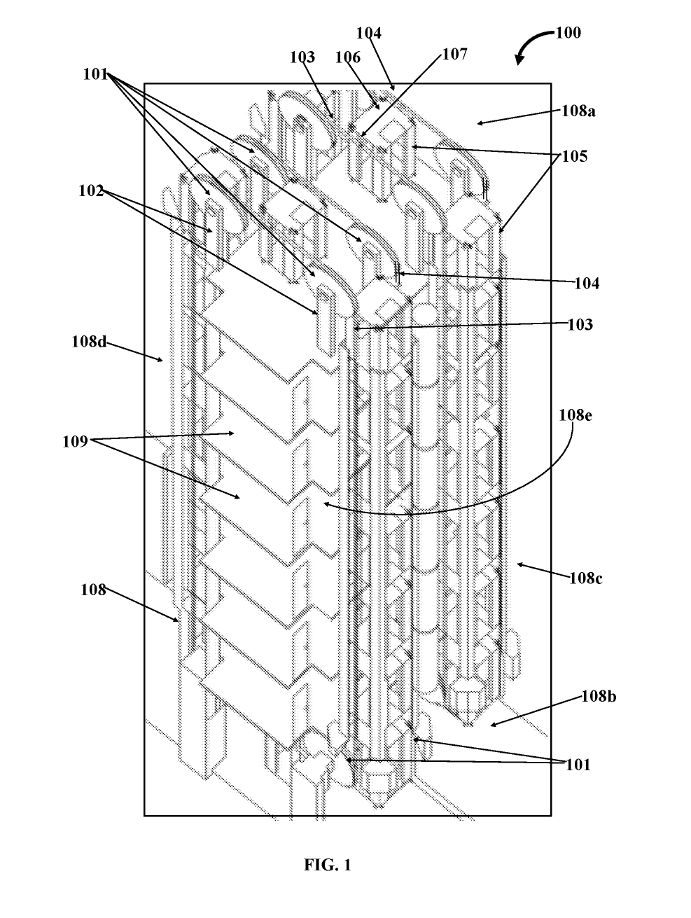

FIG. 1 exemplarily illustrates a side perspective view of the emergency entry and exit apparatus 100, further showing a three dimensional view of the compressed air channel 110. The emergency entry and exit apparatus 100 for evacuating people from a building 108, comprises a set of gears 101, mounting assemblies 102, a first chain 103, and a second chain 104, multiple cabins 105, a shaft member 107. A set of four gears 101 are fixedly attached at an upper section 108a, and another set of four gears 101 fixedly attached at a lower section 108b of the building 108 via mounting assemblies 102, where the gears 101 are positioned relative to each other in a single plain along the upper section 108a and lower section 108b of the building 108, and are interlocked in a loop via a first chain 103 and a second chain 104 in a substantially parallel orientation to each other. The cabins 105 are positioned in series along the length of the first chain 103 and the second chain 104, and a roof section 106 of each cabin 105 is attached to upper surfaces of the first chain 103 and the second chain 104 via a shaft member 107, where the first chain 103 and the second chain 104 is driven based on the difference in loading due to the weight of the people entering the cabins 105 on opposing sides 108c and 108d of the building 108 which causes the cabins 105 to be displaced along the outer contour 108e of the building 108 during the evacuation process, therefore allowing people to be safely transferred from one floor 109 to another floor 109 via the cabins 105 moving in downward direction, and to allow rescue officials to enter the building 108 through the other cabins 105 which are moving in the upward direction.

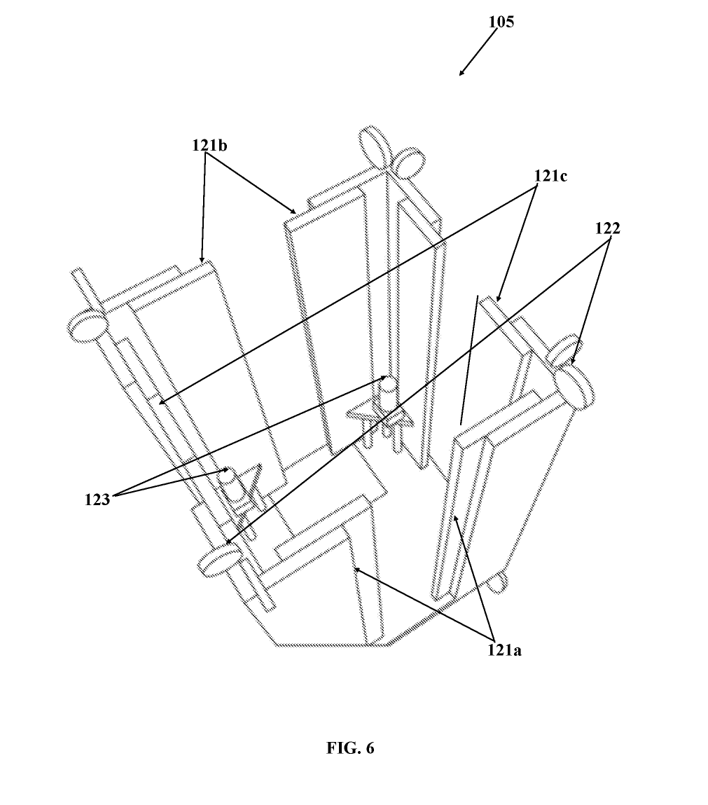

In an embodiment, the emergency entry and exit apparatus 100 further comprises compressed air channels 110 positioned between adjacent to the cabins 105 and in fluid communication with the cabins 105, where the compressed air channels 110 are configured to generate a positive air pressure within each cabin 105 to protect the people occupied within the cabin 105 from fire and smoke when cabin doors 121 are opened as shown in FIG. 6. As shown in FIG. 1 and FIG. 6, the primary object of the emergency entry and exit apparatus 100 comprises providing several fireproof cabins 105 with four cabin doors 121 that are insulated against smoke, the chains comprising the first chain 103 and the second chain 104, which connect the cabins 105 and form an interlocking circuit as shown in FIG. 1, and runners which control vertical movement of cabins 105, the gears 101 attached to the axle or the shaft 111 which connects the opposingly positioned gears 101 on the mounting assemblies 102.

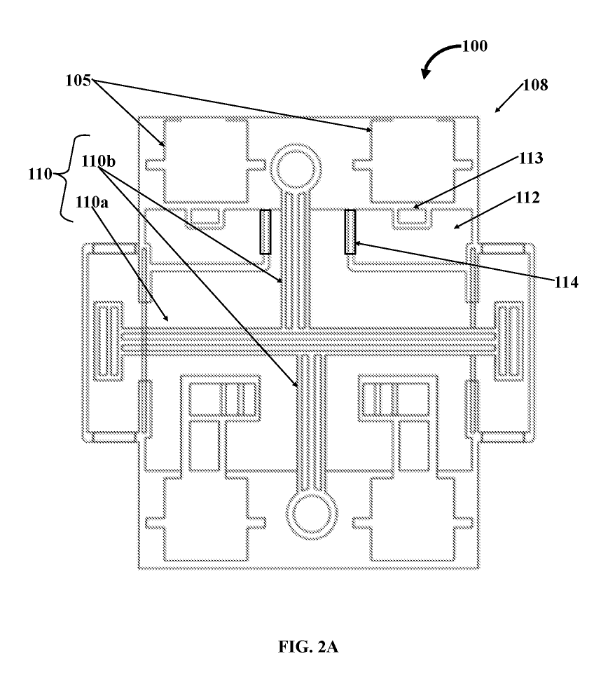

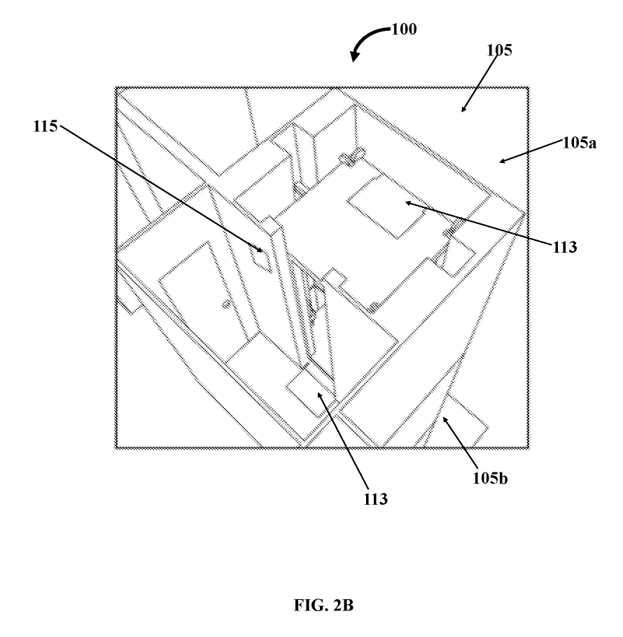

FIG. 2A exemplarily illustrates a plan view of the building 108 which shows the safe room 112 and layout of the cabin 105, and the layout of the system of compressed air channels 110 comprising of the main channel 110a and sub-branches 110b in front of the entrances to the safe rooms 112, and FIG. 2B exemplarily illustrates a top perspective view of the cabin 105, auxiliaries exit place, movable trapdoors 113, and the door which opens from one side for rescue official use. In an embodiment, the emergency entry and exit apparatus 100 further comprises safe rooms 112 positioned adjacent to the emergency entry and exit apparatus 100, where the safe rooms 112 are fitted with safe doors 114 configured to allow entry and exit of people into the emergency entry and exit apparatus 100, where each safe door 114 is configured to be accessed by a person present inside the safe room or who want to enter safe room 112. In an embodiment, the emergency entry and exit apparatus 100 further comprises movable trapdoors 113 positioned on a top portion 105a and a bottom portion 105b of each cabin 105, where if at the time of entering the cabin 105, person foot was placed between cabin 105 and movable platform, the trapdoor 113a, moves upwards to prevent their foot from injury.

As shown in FIG. 2A and FIG. 2B there is a safe door 114 in each of the safe rooms 112 which can be opened only from the inside and makes it possible for the firemen to enter damaged sections easily and without facing crowd, and leave the building 108 immediately when necessary. In an embodiment, monitoring and telemetry systems 115 are positioned in each safe room 112 configured to assist rescue officials to collect data regarding the extent of damage within the building, such as, but not limited to temperature, smoke, etc., and thereby to administer and determine their situation when leaving the safe room 112. The monitoring and telemetry systems 115 also helps the firemen to administer and determine their situation when leaving the safe room 112. There is a chance for auxiliaries in the safe room 112 to monitor the fire center, the amount of smoke, Carbon Monoxide and temperature with the use of monitoring and telemetry systems 115 which is processed by sensors installed in all floors 109. They acquire these information as soon as reaching the damaged floor 109 and before leaving the safe room 112. Therefore, the auxiliaries are able to determine their strategy for rescue operation with open eyes and prevent auxiliaries' losses.

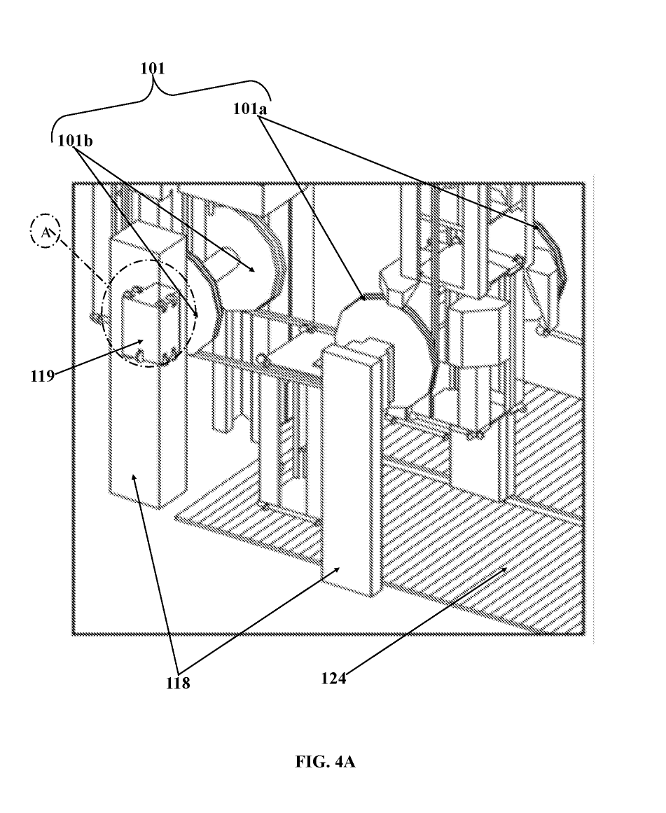

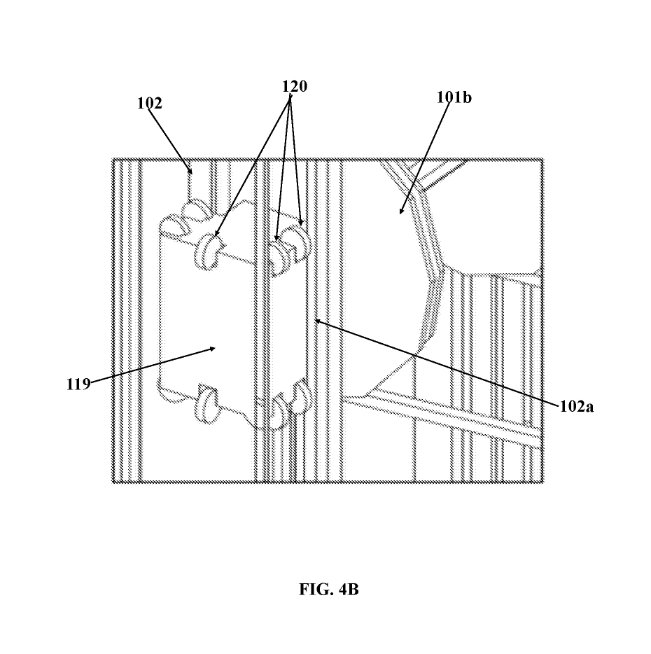

One of the prominent features of the emergency entry and exit apparatus 100 is obtaining its required energy by converting potential energy of people's weight into kinetic energy and using the raised surplus of the energy to rotate the generators which supply cabins' 105 light, and the required energy for actuating the air compressors which supply air through the compressed air channels 110 and moveable platforms 117. In order to resist earthquake and to control expansion and contraction, the emergency entry and exit apparatus 100 is connected to a floating foundation. The lower gears 101 proximal to the lower section 108b of the building 108 are connected to two floating gearboxes from two sides, the gearboxes are in two housings, placed on steel wheels and move up and down as shown in FIG. 4. The emergency entry and exit apparatus 100 and steel bearings, with the help of which the emergency entry and exit apparatus 100 is floating, are placed in the foundation.

The collection of gears 101 and gearboxes cause elongation of the chains 103 and 104 and in case of a change in the length of the chains 103 and 104 they, with their permanent expansion and contraction, put it under pressure and act as a tightener for the chains 103 and 104. The aforementioned procedure makes the emergency entry and exit apparatus 100 to move freely but under control. Therefore, at the time of earthquake occurrence, the emergency entry and exit apparatus 100 is stable and usable. In an example, it must be mentioned that the floating foundation of the emergency entry and exit apparatus 100 finds application in construction industry and bridge construction industry specially in constructing hanging bridges in order to control earthquake shaking and the expansion and contraction of tensile cables to which the bridge deck is connected. In another example, considering the evacuation rate of the emergency entry and exit apparatus 100, with simultaneous use of four systems or the four pathways for the movement of the cabins 105, a building 108 with a population of 4,800 people, with a height of 300 meters will be evacuated completely within 30 minutes.

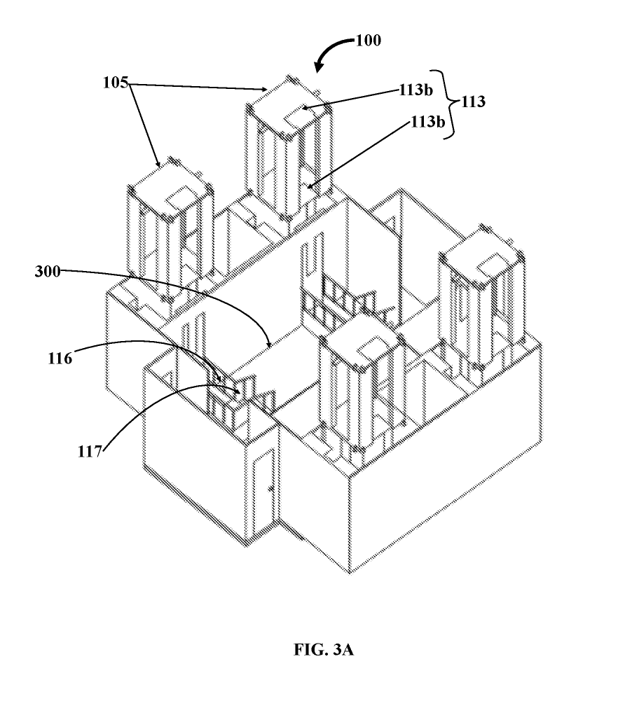

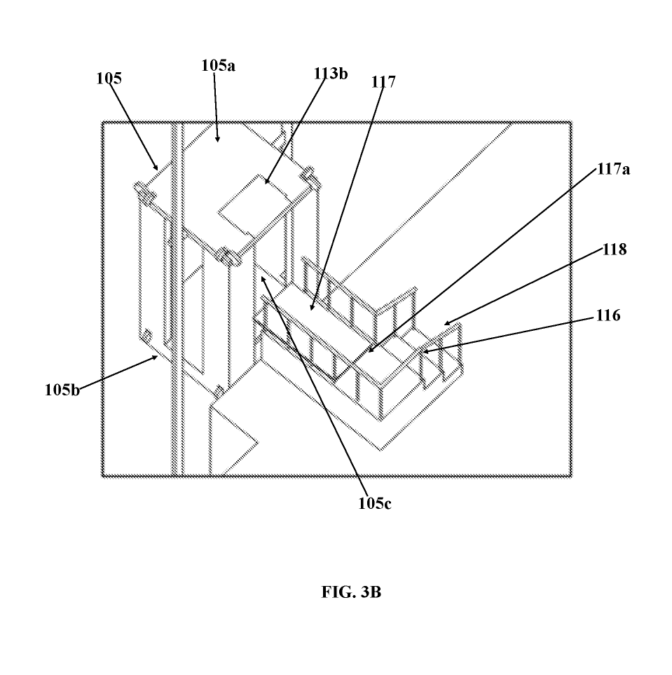

FIG. 3A exemplarily illustrates a top perspective view of a partially exploded view of a floor 109 of the building 108, showing the emergency entry and exit apparatus 100, where the safe room 112 consists of safe room entrance or a safe door 114, stairs 116 and entrance platform or movable platform 117 in front of the cabins 105 moving downward, and special entrance gates for the auxiliaries to enter the scene through the safe room 112. FIG. 3B exemplarily illustrates a top perspective enlarged view of a portion of the emergency entry and exit apparatus 100 as shown in FIG. 3A, showing the cabins 105 with the stairs 116 and movable platform 117 in front of the cabins 105. In an embodiment, the movable platform 117 is configured to provide more time for the people to enter and exit in to the cabins 105, where the height of the movable platform 117 is configured to follow the movement of the cabin 105, that is, the height of the floor 105c of the cabin 105 is electronically adjusted. Further, when the cabin 105 arrives to the stair 116, the cabin 105 below starts to move parallel with the downward cabin 105, and awaits the next cabin 105 in the sequence. Position of the cabin floor 105c in front of the floor 117a of the movable platform 117 which is embedded in the stairs 116 is, for example, 70 centimeters (cm) higher than the floor 117a of the movable platform 117.

There are two moveable trapdoors 113a and 113b at the bottom 105b and top 105a of the cabin 105 which ease the process of entrance, which prevent damage to people's feet as entering the cabin 105. It means that if a man's foot, at the time of entering the cabin 105, is placed at the bottom of the cabin 105, the moveable trapdoor 113b moves upwards and the injured can safely enter the cabin 105, as shown in FIG. 3A. In the safe rooms 112, there are stairs 116 connected to a moveable platform 117, for two reasons: first, in situations where people are in a panic stairs and guard rails are used to make a corridor for people to enter the cabins 105 one by one. Second, when the cabin 105 is located at a distance of, for example, about 70 cm above the floor 117a of the movable platform 117, the moving platform 117, by the use of an electronic eye, adjusts its movement with the cabin 105 moving downward and helps people to have enough time for entering the cabin 105, as shown in FIG. 3B. As soon as evacuation, the moveable platform 117 become balanced with the stairs 116 again, and four other people stand on the moveable platform 117 to enter the next cabin 105. This moveable platform 117 is also equipped with stairs 116 and ramps for the disabled.

Conventionally, at the time of the fire, the ventilation system causes more smoke to enter the rooms. But in the emergency entry and exit apparatus 100, instead of using ventilator, there is an air handling unit at zero height of the building 108 which makes positive pressure in safe rooms 112 by the compressed air channels 110 passing through the two systems. High air volume and pressure of the safe room 112 prevent smokes and flames to enter the room 300 at the time the door is opened as shown in FIG. 3A, therefore there is an isolated space at the location of the system. In all of the safe rooms 112, safe doors 114 to the cabin 105 via the stairs 116 are controlled by an intelligent system and depending on the priorities will be opened and closed. So there will be further possibility of evacuation for the floors 109 that are in an immediate danger. All of the safe rooms 112 are connected to each other by internal stairs.

In an embodiment, the height of each cabin floor 105c and a floor in the building 108 is different at every instance of the displacement of the cabin 105 causing the people to enter the cabins 105 asynchronously, thereby preventing damage to the cabin 105 construction. The evacuation time can be increased by making the cabins 105 distance more than four meters at the bottom of the cabin 105, adding four more gears, and L-like moving of the emergency entry and exit apparatus 100. The generators of the present system have the ability to turn into motors. So, if the number of firemen who want to go upward is more than the number of people going downward, the electricity which has been stored in the batteries is used to run the system. There is a small generator connected to one of the wheels of the cabin 105. By the use of the friction between the wheel and its runner, lighting can be provided in the cabin 105 and the emergency battery of it can be charged. There is a shaft in the gearbox of the present system that can be connected to the external motor and run it. If there is a need for system movement and there is no one in the building 108 to come down, this shaft is of great help. The safe rooms 112 have door and staircase walls to connect the floors 109 together so that people can move between floors 109, if necessary. All of the dimensions and amounts have been proposed and are changeable. Cabins 105 with different capacity and different rate may be used.

In the emergency entry and exit apparatus 100, the number of the runners can be reduced from four to two. The emergency entry and exit apparatus 100 can be replace the escape stairs in tall buildings and have two distinct pathways to transfer auxiliaries upward and the injured downward, and will never be blocked. The emergency entry and exit apparatus 100 can transfer people who are trapped in the top of the building 108 downward and simultaneously transfer the auxiliaries upward without the use of electricity, Fossil fuel, or any kind of motors. The emergency entry and exit apparatus 100 has anti-fire and anti-smoke cabins 105 to help people exit from the building fire. In an embodiment, the emergency entry and exit apparatus 100 further comprises weight sensors positioned within each cabin 105 configured to automatically close the doors of the cabin 105 when the weight of the people occupied within the cabin 105 reaches a maximum safety value. The floating foundation used in the emergency entry and exit apparatus 100 works by the help of gravity and at earthquakes it remains stable and makes the rigid structure flexible. The foundation developed for the emergency entry and exit apparatus 100 is a floating one which controls the change in chains length at the time of expansion and contraction.

The emergency entry and exit apparatus 100 is able to produce electricity by the use of people's weight and conversion of potential energy into kinetic energy, and has no pollution and supplies its need for lightening the cabins 105, launching air compressors and charging all batteries. In the emergency entry and exit apparatus 100, it is possible for the firemen and the auxiliaries to reach the top floor 109 of the building 108 in the shortest possible time and without encountering other people. They can also leave the building fast and easily. The emergency entry and exit apparatus 100 is placed in a safe, fire-proof room, and the compressed air which is injected through the compressed air channels 110 make a positive pressure in the room 300 that protects the injured and prevents the spread of fire and smoke into the room 300 as the door is opened. Up and down moving platforms 117 of the emergency entry and exit apparatus 100 increases the time for entering the cabin 105 and returns the moving platforms 117 to the initial state as the cabin 105 passes the floor 109.

FIG. 4A exemplarily illustrates a side perspective view of a bottom portion 108b of the building 108, showing the fixed foundation 118 and floating foundation gearbox 119. FIG. 4B exemplarily illustrated an enlarged view of the floating foundation gearbox 119 as marked by the portion A in FIG. 4A. In an embodiment, the emergency entry and exit apparatus further comprises gearboxes 119 to control speed of the displacement of cabins 105, where the cabins 105 comprise emergency stop switches configured to stop the movement of the cabins 105, therefore allowing unloading of auxiliaries and moving injured people. In an embodiment, each mounting assembly 102 positioned at the lower section 108b of the building 108 comprises one or combination of a fixed foundation 118 and floating foundation gearboxes 119. The fixed foundation 118 is defined by, for example, vertical mounting plates configured to receive one or more of the gears 101a, and the floating foundation gearbox 119 is configured to receive another one or more of the gears 101b, where the floating foundation gearbox 119 is defined as hollow unit comprising a telescopically suspended gearbox configured to be in contact and sliding communication with the inner lining 102a of the mounting assembly 102, via roller wheels 120 connected to the floating foundation gearbox 119, to absorb the load variation in cabins 105 during entry and exit of people. The combination of fixed foundation 118 and floating foundation gearboxes 119 control the movement, expansion and contraction of the emergency entry and exit apparatus 100 along with the earthquake to make the whole system stable.

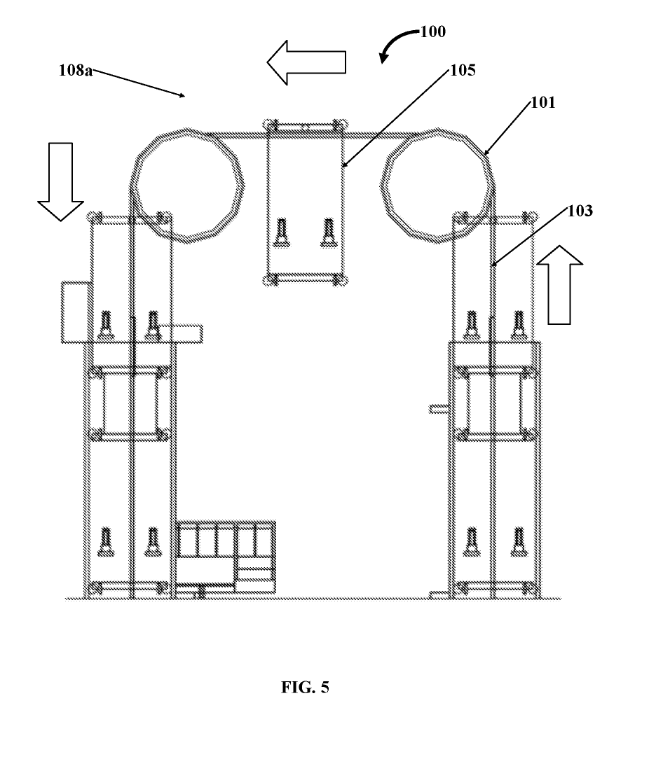

FIG. 5 exemplarily illustrates a front elevation view of the emergency entry and exit apparatus 100, showing a partial view of the cabin 105 at the time of exiting the runner, situated at the highest point or top portion 108a of the building 108, further showing horizontal movement of the cabin 105 and, and entering the next runner. At first four gears 101 are connected to the structural skeleton at the top floor 109 of the building 108 and four gears 101 are connected to four foundations 118 in the bottom portion 108b of the building 108 as shown in FIG. 4A. Then, four upper gears 101 are attached and locked to four lower gears 101 by the use of two chains 103 and 104 therefore these two chains 103 and 104 are parallel and placed together separately. The cabin 105 is then connected to the two chains 103 and 104 at similar point and by the use of a shaft member 107 as shown in FIG. 1. The emergency entry and exit apparatus 100 acts like a scale in which the balance is achieved by the row of cabins 105 on the way there and back. People's weight disrupt the balance of this scale-like system and therefore the cabin 105 moves downward and another cabin 105 takes the previous one's place immediately. The speed of the traversing of the emergency entry and exit apparatus 100 is, for example, 0.5 meter per second (m/s) and its continuous movement allows one entrance per second. The speed of the cabins 105 is regulated by the floating foundation gearboxes 119. It must be noted that the speed and number of occupants are changeable. The floating foundation gearboxes 119 of the system are equipped with an emergency stop and can interrupt the emergency entry and exit apparatus 100, for example, 10, 15 or 20 seconds. The emergency stop is provided for the time the auxiliaries need to stop the emergency entry and exit apparatus 100, for example, to unload equipment or move the injured. The emergency entry and exit apparatus 100 is connected to an electronic circuit and in case of repeated or simultaneously press in all floors 109, it only react to the first command to prevent frequent stops of the emergency entry and exit apparatus 100. As soon as occupants exit, auxiliaries and firemen are able to enter evacuated cabins 105 and, by the help of the power made by cabins 105 carrying people downward, they reach the upper floors 109 safely and in the shortest time possible.

FIG. 6 exemplarily illustrates a top perspective view of the cabin 105. In an embodiment, each cabin 105 comprises a set of doors 121, where each door 121 is, for example, a sliding door defined by adjacently positioned rectangular sliding plates configured to be slid open, and the set of doors 121 comprise a front door 121a, a rear door 121b, and a pair of side doors 121c. The front door 121a is configured to allow the entry of injured people, the rear door 121b is configured to allow entry and exit for the auxiliaries, and the side doors 121c are configured to evacuate the injured people at the lower section 108a of the building 108. In an embodiment, each cabin 105 comprises wheels 122 positioned on adjoining edges, and bearing members, where the wheels 122 and bearing members, in combination, is configured to prevent a pendulum movement of the cabin 105, and each wheel 122 is positioned on a spring member to prevent damage to the cabin 105 caused by vibrations. In an example, each wheel 122 is positioned at a distance of, for example, 4 meters from each other. By decreasing the friction between the floor 117a of the movable platform 117 and the cabin floor 105c, these wheels 122 decrease cabin's 105 pressure on the chains 102 and 103 at the time of horizontal movement. In an embodiment, the emergency entry and exit apparatus 100 further comprises one or more oxygen cylinders 123 positioned within each cabin 105 to provide oxygen for the people being evacuated from the building 108.

At the evacuation place, the cabin 105 moves, for example, about 4 meters horizontally to give people the chance to leave the cabin 105 and step easily on the movable platform 124 at the rate of which is, for example, 0.5 m/s. The movable platform 124 moves parallel to the cabin 105 and as the floating foundation gearbox 119 moves up or down, it uses an electronic eye to set its height with the cabin floor 105c. Where the cabin 105 changes its horizontal movement to vertical, on the top portion and bottom portion with respect to the emergency entry and exit apparatus 100, there is a curved part that helps it to enter the runner.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

What is claimed is:

1. An emergency entry and exit apparatus for evacuating people from a building, comprising:
a set of four gears fixedly attached at an upper section, and another set of four gears fixedly attached at a lower section of the building via mounting assemblies, wherein the gears positioned relative to each other in a single plain along the upper section and lower section of the building are interlocked in a loop via a first chain and a second chain in a substantially parallel orientation to each other; and
a plurality of cabins positioned in series along the length of the first chain and the second chain, and a roof section of each cabin attached to upper surfaces of the first chain and the second chain via a shaft member, wherein the first chain and the second chain are driven based on the difference in loading due to the weight of the people entering the cabins on opposing sides of the building causing the cabins to be displaced along the outer contour of the building during the evacuation process, therefore allowing people to be safely transferred from one floor to another floor via the cabins moving in downward direction, and to allow rescue officials to enter the building through the other cabins which are moving in the upward direction.

2. The emergency entry and exit apparatus of claim 1, further comprising gearboxes to control speed of the displacement of cabins, wherein the cabins comprise emergency stop switches configured to stop the movement of the cabins, therefore allowing unloading of auxiliaries and moving injured people.

3. The emergency entry and exit apparatus of claim 1, further comprising compressed air channels positioned between adjacent to the cabins and in fluid communication with the cabins, wherein the compressed air channels are configured to generate a positive air pressure within each cabin and also safe room to protect the people occupied within the cabin from fire and smoke when cabin doors are opened.

4. The emergency entry and exit apparatus of claim 1, further comprising safe rooms positioned adjacent to the emergency entry and exit apparatus, wherein the safe rooms are fitted with a safe doors configured to allow entry and exit of people into the emergency entry and exit apparatus, wherein a door of another room inside the safe room is configured to be accessed exclusively by a auxiliaries inside the room.

5. The emergency entry and exit apparatus of claim 1, wherein each mounting assembly positioned at the lower section of the building comprises one or combination of:
a fixed foundation defined by vertical mounting plates configured to receive one or more of the gears; and
a floating foundation gearbox configured to receive one or more of the gears, wherein the floating foundation gearbox is defined as hollow unit comprising a telescopically suspended gearbox configured to be in contact and sliding communication with the inner lining of the mounting assembly to absorb the system variation and elongation of the first chain and the second chain during entry and exit of people.

6. The emergency entry and exit apparatus of claim 1, further comprising one or more oxygen cylinders positioned within each cabin to provide oxygen for the people being evacuated from the building.

7. The emergency entry and exit apparatus of claim 1, wherein each cabin comprises a set of doors, wherein each door is a sliding door defined by adjacently positioned rectangular sliding plates configured to be slid open, the set of doors comprising;
a front door configured to allow the entry of injured people;
a rear door configured to allow entry and exit for the auxiliaries; and
a pair of side doors configured to evacuate the injured people at the lower section of the building.

8. The emergency entry and exit apparatus of claim 1, wherein a movable platform configured to provide more time for the people to enter and exit in to the cabins, wherein the height of the movable platform is configured to follow the cabin movement electronically, wherein when the cabin arrives to the stair, the cabin below starts to move parallel with the downward cabin, and awaits the next cabin in the sequence.

9. The emergency entry and exit apparatus of claim 1, wherein each cabin comprises wheels positioned on adjoining edges, and bearing members, wherein the wheels and bearing members, in combination, is configured to prevent pendulum movement of the cabin.

10. The emergency entry and exit apparatus of claim 9, wherein each wheel is positioned on a spring member to prevent damage caused by vibrations.

11. The emergency entry and exit apparatus of claim 1, further comprising movable trapdoors positioned on a top portion and a bottom portion of each cabin, wherein when a person's foot is placed between cabin and movable platform, the trapdoor moves upwards to prevent their foot from injury.

12. The emergency entry and exit apparatus of claim 1, wherein the height of each cabin floor and a floor in the building is different at every instance of the displacement of the cabin causing the people to enter the cabins asynchronously, thereby preventing damage to the cabin construction.

13. The emergency entry and exit apparatus of claim 1, further comprising weight sensors positioned within each cabin configured to automatically close the doors of the cabin when the weight of the people occupied within the cabin reaches a maximum safety value.

14. The emergency entry and exit apparatus of claim 1, wherein monitoring and telemetry systems are positioned in each safe room configured to assist rescue officials to collect data regarding the extent of damage within the building, and thereby to administer and determine their situation when leaving the safe room.
